(19) United States
(12) Patent Application Publication
(10) Pub. No.: US 2018/0183267 A1
(43) Pub. Date: Jun. 28, 2018

(54) WIRELESS POWER TRANSMITTER AND WIRELESS CHARGING METHOD

(71) Applicant: Foxconn Technology Co., Ltd., New Taipei (TW)

(72) Inventor: Yung-Ping LIN, Tu-Cheng (TW)

(21) Appl. No.: 15/444,495

(22) Filed: Feb. 28, 2017

(30) Foreign Application Priority Data
Dec. 27, 2016 (CN) 201611226423.0

(51) Int. Cl. H02J 50/12; H02J 7/02; H02J 50/60; H02J 7/00; H02J 50/80; H04W 4/00; H04B 5/00

(52) U.S. Cl. CPC H02J 50/12; H02J 7/025; H02J 50/60; H04B 5/0037; H02J 50/80; H04W 4/008; H02J 7/0047

(57) ABSTRACT

A wireless power transmitter with protection against damage to Near Field Communication (NFC) devices within range includes a DC/DC converter, a power transmitting controller, an MCU, a switch having two switching ports, a matching unit having two capacitors connected in parallel, and a coil. The DC/DC converter converts a supplied direct current to another level and outputs the direct current before the wireless power transmitter is activated. The converted DC causes one switch port to be conductive, thereby the first capacitor and the coil cooperatively generate a first resonant frequency equal to NFC operating frequency. The power transmitting controller transmits a control signal to the coil which can determine the presence of an NFC device within the wireless charging field. The power transmitting controller is turned off if an NFC device is within the field.

### FIELD

The subject matter herein generally relates to power charging, and more particularly, to a wireless power transmitter and a wireless charging method.

### BACKGROUND

Rezence is an interface standard developed by Alliance for Wireless Power (A4WP) for wireless electrical power transfer based on principles of magnetic resonance. A Rezence system comprises a single power transmitter unit (PTU) and at least one power receiver unit (PRU). The PTU is configured to transmit wireless electrical power to each PRU within the wireless charging field when the PTU is powered on.

However, an operating frequency of Rezence is much greater than that of Near Field Communication (NFC). If an NFC device is also within the wireless charging field, a large electrical current may be passed to the NFC device caused by doubling frequency vibration at the time the PTU is powered on. Thus, the NFC device may generate excess heat that can lead to a burnout.

### BRIEF DESCRIPTION OF THE DRAWINGS

Implementations of the present technology will now be described, by way of example only, with reference to the attached figures.

FIG. 1 is a block diagram of an exemplary embodiment of a wireless power transmitter according to the present disclosure.

FIG. 2 is a flowchart of an exemplary embodiment of a wireless charging method according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

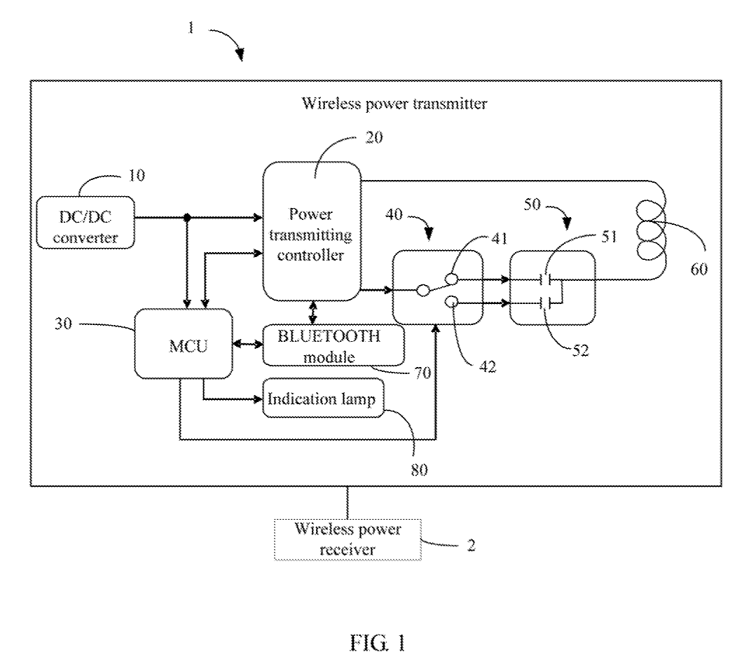

FIG. 1 illustrates an exemplary embodiment of a wireless power transmitter 1. The wireless power transmitter 1 can wirelessly communicate with and wirelessly transmit electrical power to a wireless power receiver 2. The wireless power receiver 2 can be a smart phone, a tablet computer, or a multimedia player.

The wireless power transmitter 1 comprises a DC/DC converter 10, a power transmitting controller 20, a microcontroller unit (MCU) 30, a switch 40, a matching unit 50, a coil 60, and a BLUETOOTH module 70. The DC/DC converter 10 is electrically connected to a power source (not shown) of the wireless power transmitter 1. The power transmitting controller 20 is electrically connected to the DC/DC converter 10. The MCU 30 is electrically connected to the DC/DC converter 10 and the power transmitting controller 20. The switch 40 is electrically connected between the power transmitting controller 20 and the matching unit 50. The switch 40 comprises a first switching port 41 and a second switching port 42. The matching unit 50 comprises a first capacitor 51 and a second capacitor 52 connected in parallel. The first capacitor 51 is electrically connected to the first switching port 41. The second capacitor 52 is electrically connected to the second switching port 42. The first capacitor 51 and the second capacitor 52 have different capacitance values. The coil 60 is electrically connected between the power transmitting controller 20 and the matching unit 50. The BLUETOOTH module 70 is electrically connected to the MCU 30 and the power transmitting controller 20.

When the wireless power transmitter 1 is powered on and the power source outputs a direct current, the DC/DC converter 10 converts the direct current from an original level and outputs the direct current at another level.

The power transmitting controller 20 maintains in an off state when the DC/DC converter 10 outputs the direct current. That is, the power transmitting controller 20 does not output any signal.

The MCU 30 controls the first switch port 41 of the switch 40 to be conductive such that the first capacitor 51 is electrically connected to the coil 60 when the DC/DC converter 10 outputs the direct current, thereby the first capacitor 51 and the coil 60 cooperatively generate a first resonant frequency. The first resonant frequency is equal to the operating frequency of the NFC (that is, 13.56 MHz). The MCU 30 further turns on the power transmitting controller 20 and controls the power transmitting controller 20 to transmit a control signal to the coil 60.

The coil 60 scans within a wireless charging field of the wireless power transmitter 1 at the first resonant frequency in response to the control signal, to determine whether at least one NFC device is within the wireless charging field.

When at least one NFC device is within the wireless charging field, the MCU 30 turns off the power transmitting controller 20, that is, the MCU 30 disables the function of wireless charging of the wireless power transmitter 1, thereby preventing the NFC device from being damaged by the operating frequency of the wireless power transmitter 1 performing wireless charging. In at least one exemplary embodiment, the wireless power transmitter 1 further comprises at least one indication lamp (for example, an LED) 80 electrically connected to the MCU 30. The MCU 30 further controls the indication lamp 80 to emit light, thereby reminding a user that the at least one NFC device is within the wireless charging field. For example, the MCU 30 can control the indication lamp 80 to emit red light.

When no NFC device is within the wireless charging field, the MCU 30 controls the second switch port 42 of the switch 40 to be conductive such that the second capacitor 52 is electrically connected to the coil 60, thereby the second capacitor 52 and the coil 60 cooperatively generate a second resonant frequency different from the first resonant frequency. The second resonant frequency is equal to the operating frequency of the wireless power transmitter 1 performing wireless charging. The second resonant frequency is usually greater than the first resonant frequency. As such, the wireless power transmitter 1 is switched to the wireless charging mode. The MCU 30 further controls the power transmitting controller 20 to transmit a shortwave electrical power to the coil 60 such that the coil 60 transmits such shortwave electrical power by magnetic resonance to a coil (not shown) of the wireless power receiver 2. As such, the power source (not shown) of the wireless power receiver 2 is activated, which allows a BLUETOOTH module (not shown) of the wireless power receiver 2 to wirelessly communicate with the BLUETOOTH module 70 of the wireless power transmitter 1.

The BLUETOOTH module 70 broadcasts an authentication signal within the wireless charging field at a preset time point after the power transmitting controller 20 transmits the shortwave electrical power to the coil 60. As long as the wireless power receiver 2 remains within the wireless charging field, the BLUETOOTH module of the wireless power receiver 2 can receive the authentication signal and transmit a feedback signal to the BLUETOOTH module 70.

The MCU 30 controls the power transmitting controller 20 to continuously transmit electrical power to the wireless power receiver 2 as long as the BLUETOOTH module 70 receives the feedback signal, thereby performing wireless charging.

The BLUETOOTH module 70 can further communicate with the wireless power receiver 2 for other purposes. When the MCU 30 controls the power transmitting controller 20 to continuously transmit electrical power to the wireless power receiver 2, the BLUETOOTH module 70 further communicates with the wireless power receiver 2 to authenticate, protect over-current, detect foreign-object, or any combination thereof.

The MCU 30 further determines whether the charging of the wireless power receiver 2 is complete according to a communication result between the BLUETOOTH module 70 and the wireless power receiver 2. When charging of the wireless power receiver 2 is complete, the MCU 30 turns off the power transmitting controller 20 and controls the wireless power transmitter 1 to enter a standby state.

With the above configuration, the wireless power transmitter 1 can detect any NFC device within the wireless charging field before the wireless power transmitter 1 is powered on and transmits power. Thus, damage to an NFC device by the operating frequency of the wireless power transmitter 1 performing wireless charging can be prevented.

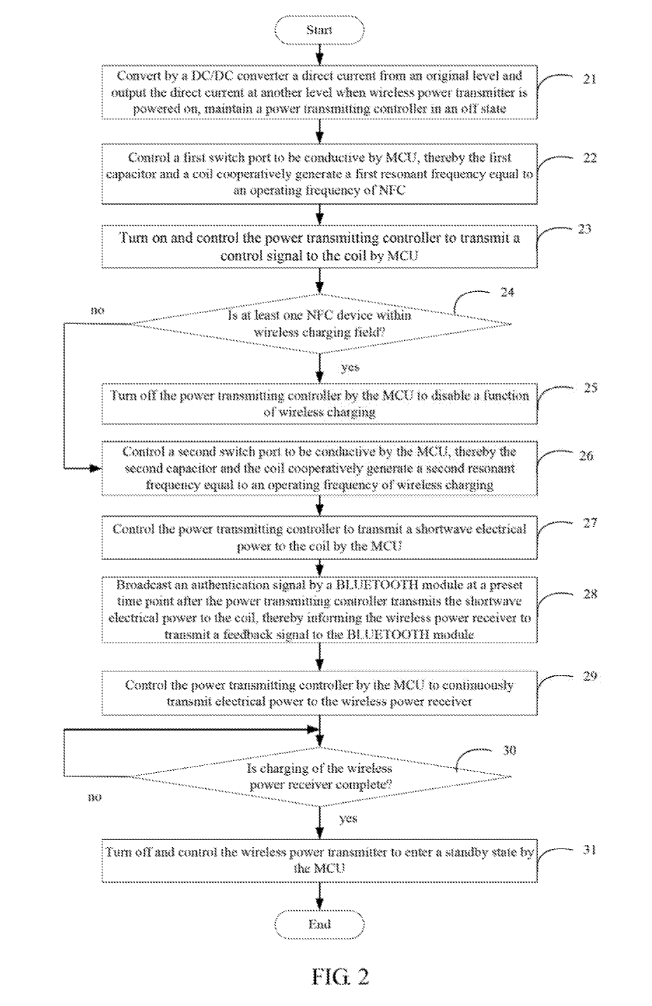

Referring to FIG. 2, a flowchart is presented in accordance with an example embodiment. The exemplary wireless charging method is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods or subroutines, carried out in the exemplary method. Additionally, the illustrated order of blocks is by example only and the order of the blocks can change. The exemplary wireless charging method can begin at block 21.

At block 21, the DC/DC converter 10 converts a direct current from an original level and outputs the direct current at another level, when the wireless power transmitter 1 is powered on and the power source outputs the direct current, the power transmitting controller maintains in an off state.

At block 22, the MCU 30 controls the first switch port 41 of the switch 40 to be conductive such that the first capacitor 51 is electrically connected to the coil 60 when the DC/DC converter 10 outputs the direct current, thereby the first capacitor 51 and the coil 60 cooperatively generate a first resonant frequency. The first resonant frequency is equal to the operating frequency of NFC.

At block 23, the MCU 30 further turns on the power transmitting controller 20 and controls the power transmitting controller 20 to transmit a control signal to the coil 60.

At block 24, the coil 60 scans within a wireless charging field of the wireless power transmitter 1 at the first resonant frequency in response to the control signal to determine whether at least one NFC device is within the wireless charging field. If yes, the procedure goes to block 25; otherwise, the procedure goes to block 26.

At block 25, the MCU 30 turns off the power transmitting controller 20.

At block 26, the MCU 30 controls the second switch port 42 of the switch 40 to be conductive such that the second capacitor 52 is electrically connected to the coil 60, thereby the second capacitor 52 and the coil 60 cooperatively generate a second resonant frequency different from the first resonant frequency. The second resonant frequency is equal to the operating frequency of the wireless power transmitter 1 performing wireless charging. The second resonant frequency is usually greater than the first resonant frequency. As such, the wireless power transmitter 1 is switched to the wireless charging mode.

At block 27, the MCU 30 controls the power transmitting controller 20 to transmit a shortwave electrical power to the coil 60 such that the coil 60 transmits such shortwave electrical power by magnetic resonance to the coil of the wireless power receiver 2. As such, the power source of the wireless power receiver 2 is activated.

At block 28, the BLUETOOTH module 70 broadcasts an authentication signal within the wireless charging field at a preset time point after the power transmitting controller 20 transmits the shortwave electrical power to the coil 60, thereby informing the wireless power receiver 2 remained within the wireless charging field to transmit a feedback signal to the BLUETOOTH module 70.

At block 29, the MCU 30 controls the power transmitting controller 20 to continuously transmit electrical power to the wireless power receiver 2 when the BLUETOOTH module 70 receives the feedback signal, thereby performing wireless charging.

At block 30, the MCU 30 further determines whether charging of the wireless power receiver 2 is complete. If yes, the procedure goes to block 31; otherwise, block 30 is repeated.

At block 31, the MCU 30 turns off the power transmitting controller 20 and controls the wireless power transmitter 1 to enter a standby state.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A wireless power transmitter comprising:
a DC/DC converter configured to convert a direct current from an original level and output the direct current at another level when the wireless power transmitter being powered on and a power source of the wireless power transmitter output the direct current;
a power transmitting controller configured to maintain in an off state when the DC/DC converter output the direct current;
a switch having a first switching port and a second switching port;
a matching unit having a first capacitor and a second capacitor connected in parallel; and
a coil; and
a microcontroller unit (MCU) configured to control the first switch port to be conductive such that the first capacitor being electrically connected to the coil when the DC/DC converter output the direct current, thereby the first capacitor and the coil cooperatively generate a first resonant frequency; wherein the first resonant frequency is equal to an operating frequency of NFC; wherein the MCU is further configured to turn on the power transmitting controller and control the power transmitting controller to transmit a control signal to the coil;
wherein the coil is configured, to scan within a wireless charging field of the wireless power transmitter at the first resonant frequency in response to the control signal to determine whether at least one NFC device is within the wireless charging field;
wherein the MCU is further configured to turn off the power transmitting controller to disable a function of wireless charging of the wireless power transmitter when at least one NFC device is within the wireless charging field.

2. The wireless power transmitter of claim 1, further comprising a BLUETOOTH module, wherein the MCU is further configured to control the second switch port to be conductive such that the second capacitor is electrically connected to the coil when no NFC device is within the wireless charging field, thereby the second capacitor and the coil cooperatively generate a second resonant frequency different from the first resonant frequency, the second resonant frequency is equal to an operating frequency of the wireless power transmitter performing wireless charging; wherein the MCU is further configured to control the power transmitting controller to transmit a shortwave electrical power to the coil such that the coil transmits the shortwave electrical power by magnetic resonance to a wireless power receiver, thereby allowing a power source of the wireless power receiver to be activated; wherein the BLUETOOTH module is configured to broadcast an authentication signal within the wireless charging field at a preset time point after the power transmitting controller transmits the shortwave electrical power to the coil, thereby informing the wireless power receiver remained in the wireless charging field to transmits a feedback signal to the BLUETOOTH module; wherein the MCU is further configured to control the power transmitting controller to continuously transmit electrical power to the wireless power receiver when the BLUETOOTH module receives the feedback signal, thereby performing wireless charging.

3. The wireless power transmitter of claim 2, wherein the BLUETOOTH module is further configured to communicate with the wireless power receiver to authenticate, protect over-current, detect foreign-object, or any combination thereof when the MCU controls the power transmitting controller to continuously transmit electrical power to the wireless power receiver.

4. The wireless power transmitter of claim 2, wherein the MCU is further configured to determine whether charging of the wireless power receiver is complete, the MCU is further configured to turn off the power transmitting controller and control the wireless power transmitter to enter a standby state when the charging of the wireless power receiver is complete.

5. The wireless power transmitter of claim 1, further comprising at least one indication lamp, wherein the MCU is further configured to control the indication lamp to emit light when at least one NFC device is within the wireless charging field.

6. The wireless power transmitter of claim 5, wherein the MCU is configured to control the indication lamp to emit red light.

7. A wireless charging method applied in a wireless power transmitter, the wireless power transmitter comprising a DC/DC converter, a power transmitting controller, a microcontroller unit (MCU), a switch having a first switching port and a second switching port, a matching unit having a first capacitor and a second capacitor connected in parallel, and a coil, the wireless charging method comprising:
converting, by the DC/DC converter, a direct current from an original level and outputting the direct current at another level when the wireless power transmitter being powered on and a power source of the wireless power transmitter output the direct current; wherein the power transmitting controller maintains in an off state when the DC/DC converter outputs the direct current;
controlling, by the MCU, the first switch port to be conductive such that the first capacitor being electrically connected to the coil when the DC/DC converter output the direct current, thereby the first capacitor and the coil cooperatively generate a first resonant frequency, the first resonant frequency being equal to an operating frequency of NFC;
turning, by the MCU, on the power transmitting controller and controlling the power transmitting controller to transmit a control signal to the coil;
scanning, by the coil, within a wireless charging field of the wireless power transmitter at the first resonant frequency in response to the control signal to determine whether at least one NFC device being within the wireless charging field; and
turning, by the MCU, off the power transmitting controller to disable a function of wireless charging of the wireless power transmitter when at least one NFC device being within the wireless charging field.

8. The wireless charging method of claim 7, further comprising:
controlling, by the MCU, the second switch port to be conductive such that the second capacitor is electrically connected to the coil when no NFC device is within the wireless charging field, thereby the second capacitor and the coil cooperatively generate a second resonant frequency different from the first resonant frequency, the second resonant frequency is equal to an operating frequency of the wireless power transmitter performing wireless charging;
controlling, by the MCU, the power transmitting controller to transmit a shortwave electrical power to the coil such that the coil transmits the shortwave electrical power by magnetic resonance to a wireless power receiver, thereby allowing a power source of the wireless power receiver to be activated;
broadcasting, by a BLUETOOTH module, an authentication signal within the wireless charging field at a preset time point after the power transmitting controller transmits the shortwave electrical power to the coil, thereby informing the wireless power receiver remained in the wireless charging field to transmits a feedback signal to the BLUETOOTH module; and
controlling, by the MCU, the power transmitting controller to continuously transmit electrical power to the wireless power receiver when the BLUETOOTH module receives the feedback signal, thereby performing wireless charging.

9. The wireless charging method of claim 8, further comprising:
communicating, by the BLUETOOTH module, with the wireless power receiver to authenticate, protect over-current, detect foreign-object, or any combination thereof when the MCU controls the power transmitting controller to continuously transmit electrical power to the wireless power receiver.

10. The wireless charging method of claim 8, further comprising:
determining, by the MCU, whether charging of the wireless power receiver is complete; and
turning off, by the MCU, the power transmitting controller and controlling the wireless power transmitter to enter a standby state when the charging of the wireless power receiver is complete.

11. The wireless charging method of claim 7, further comprising:
controlling, by the MCU, at least one indication lamp to emit light when at least one NFC device is within the wireless charging field.
